(19) United States
(12) Patent Application Publication
(10) Pub. No.: US 2025/0381779 A1
(43) Pub. Date: Dec. 18, 2025

(54) LIQUID DISCHARGE HEAD, HEAD MODULE, LIQUID DISCHARGE UNIT, AND LIQUID DISCHARGE APPARATUS

(71) Applicants: Takuma HIRABAYASHI, Tokyo (JP); Akio YOSHITA, Kanagawa (JP)

(72) Inventors: Takuma HIRABAYASHI, Tokyo (JP); Akio YOSHITA, Kanagawa (JP)

(21) Appl. No.: 19/235,683

(22) Filed: Jun. 12, 2025

(30) Foreign Application Priority Data
Jun. 14, 2024 (JP) 2024-097030

(51) Int. Cl. B41J 2/14; B41J 2/175; B41J 25/00

(52) U.S. Cl. CPC B41J 2/1433; B41J 2/14233; B41J 2/175; B41J 25/005; B41J 2002/14475

(57) ABSTRACT

A liquid discharge head includes a nozzle substrate, an actuator substrate, a diaphragm, and an actuator element. The nozzle substrate has multiple nozzles arrayed in an array direction on a nozzle face to discharge a liquid from the multiple nozzles. Each of the multiple nozzles has a nozzle inlet and a nozzle outlet downstream of the nozzle inlet. The nozzle inlet has a first cross-sectional area and a first center line at a center of the nozzle inlet. The nozzle outlet has a second cross-sectional area and a second center line at a center of the nozzle outlet. The second cross-sectional area is smaller than the first cross-sectional area. The second center line is shifted from the first center line in the array direction for a shift amount that gradually increases from a center of the multiple nozzles toward each end of the multiple nozzles.

### CROSS-REFERENCE TO RELATED APPLICATION

This patent application is based on and claims priority pursuant to 35 U.S.C. § 119 (a) to Japanese Patent Application No. 2024-097030, filed on Jun. 14, 2024, in the Japan Patent Office, the entire disclosure of which is hereby incorporated by reference herein.

### BACKGROUND

### Technical Field

The present disclosure relates to a liquid discharge head, a head module, a liquid discharge unit, and a liquid discharge apparatus.

### Related Art

In the related art, a liquid discharge head includes multiple nozzles, multiple pressure chambers, a diaphragm, and an actuator element. The multiple nozzles are arrayed in a predetermined array direction. The multiple pressure chambers respectively communicate with the multiple nozzles. The diaphragm has wall portions of the multiple pressure chambers. The actuator element drives (deforms) the diaphragm.

### SUMMARY

The present disclosure described herein provides an improved liquid discharge head including a nozzle substrate, an actuator substrate, a diaphragm, and an actuator element. The nozzle substrate has multiple nozzles arrayed in an array direction on a nozzle face to discharge a liquid from the multiple nozzles in a discharge direction intersecting the array direction. The actuator substrate is disposed on the nozzle substrate. The actuator substrate has multiple pressure chambers arrayed in the array direction and respectively communicating with the multiple nozzles. The diaphragm is disposed on the actuator substrate. The diaphragm has wall portions respectively facing the multiple nozzles across the multiple pressure chambers in the discharge direction. The actuator element is disposed on the diaphragm to deform the diaphragm. Each of the multiple nozzles has a nozzle inlet communicating with a corresponding pressure chamber of the multiple pressure chambers and a nozzle outlet downstream of the nozzle inlet in the discharge direction. The nozzle inlet has a first cross-sectional area orthogonal to a target direction orthogonal to the nozzle face and a first center line at a center of the nozzle inlet in the array direction. The nozzle outlet has a second cross-sectional area orthogonal to the target direction and a second center line at a center of the nozzle outlet in the array direction. The second cross-sectional area is smaller than the first cross-sectional area. The second center line is shifted from the first center line in the array direction for a shift amount that gradually increases from a center of the multiple nozzles toward each end of the multiple nozzles in the array direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a head unit as viewed in a normal direction of a recording material;

FIG. 2 is a diagram illustrating an arrangement of recording heads in each recording unit of the head unit of FIG. 1;

FIG. 3A is a perspective view of one head module as viewed from a nozzle face (discharge face) side;

FIG. 3B is a perspective view of the head module of FIG. 3A as viewed from the side opposite the nozzle face;

FIG. 4 is a plan view of the nozzle face of the head module of FIG. 3A;

FIG. 5 is a cross-sectional view of a recording head taken in a longitudinal direction of a piezoelectric element at a position of one nozzle (a central nozzle in a nozzle array direction);

FIG. 6 is a cross-sectional view of the recording head of FIG. 5, taken in a transverse direction of the piezoelectric element at the position of the one nozzle (the central nozzle in the nozzle array direction);

FIG. 7A is a diagram illustrating a landing position deviation in a nozzle array in which multiple nozzles having a typical nozzle structure are arrayed according to a comparative example;

FIG. 7B is a graph illustrating the amount of the landing position deviation of FIG. 7A, which is indicated by a deviation angle generated in each nozzle;

FIG. 8A is a diagram illustrating a landing position deviation in a nozzle array in which multiple nozzles having a typical nozzle structure are arrayed according to another comparative example;

FIG. 8B is a graph illustrating the amount of the landing position deviation of FIG. 8A, which is indicated by a deviation angle generated in each nozzle;

FIG. 9 is a diagram of a recording head as viewed from a nozzle face side, illustrating a structure (a positional relationship in an in-plane direction of the nozzle face) of multiple nozzles of a nozzle array;

FIG. 10 is a diagram of another recording head as viewed from a nozzle face side, illustrating a structure (a positional relationship in an in-plane direction of the nozzle face) of multiple nozzles of a nozzle array;

FIG. 11 is a graph illustrating a shift amount in a nozzle array with an average change rate of the shift amount of 0.0009 μm/nozzle from a central nozzle to each end nozzle in a nozzle array direction in the recording head of FIG. 10;

FIG. 12 is a diagram illustrating a landing position deviation of liquid discharged from nozzles in end regions in a nozzle array of two recording heads as illustrated in FIG. 7A;

FIG. 13A is a graph illustrating the amount of a landing position deviation, which is indicated by a deviation angle, generated in each nozzle in a recording head having a configuration illustrated in FIG. 9 when the landing position deviation as illustrated in FIG. 7A occurs;

FIG. 13B is a graph illustrating the amount of a landing position deviation, which is indicated by a deviation angle, generated in each nozzle in a recording head having a configuration illustrated in FIG. 10 when the landing position deviation as illustrated in FIG. 8A occurs;

FIG. 14 is a diagram of yet another recording head as viewed from a nozzle face side, illustrating a structure of multiple nozzles of a nozzle array;

FIG. 15 is a plan view of a part of a liquid discharge apparatus;

FIG. 16 is a side view of the part of the liquid discharge apparatus of FIG. 15;

FIG. 17 is a plan view of a part of a liquid discharge unit; and

FIG. 18 is a front view of another liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a head unit, including a liquid discharge head, of an inkjet recording apparatus as an image forming apparatus that is a liquid discharge apparatus to discharge a liquid.

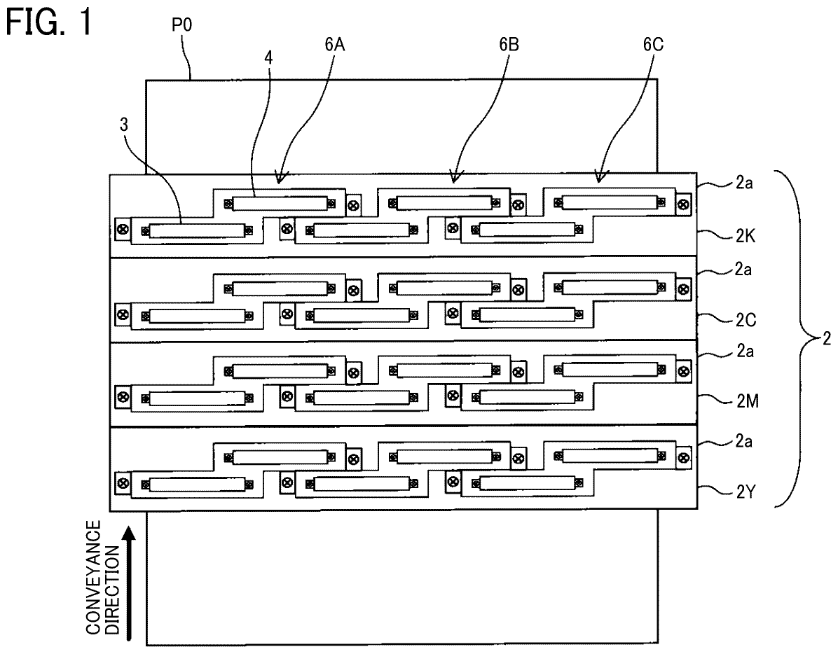

A head unit will be described below. FIG. 1 is a plan view of a head unit 2 as viewed in a normal direction of a recording material P0 as a recording medium (may be referred to simply as a medium). Examples of the recording material P0 include a sheet (e.g., paper). The sheet may be a roll sheet (continuous sheet) or a cut sheet. In addition, various media (e.g., cloth) other than the sheet may be used as the recording material P0. The recording material P0 is conveyed in a conveyance direction indicated by the arrow in FIG. 1. The head unit 2 is supported so as to face a recording surface of the recording material P0 with a predetermined gap therebetween.

The head unit 2 includes a recording unit 2K, a recording unit 2C, a recording unit 2M, and a recording unit 2Y as liquid discharge head devices for respective colors corresponding to respective inks (liquids) of black (K), cyan (C), magenta (M), and yellow (Y).

Each of the recording units 2K, 2C, 2M, and 2Y of the respective colors includes three head modules 6A, 6B, and 6C each including two recording heads 3 and 4 as liquid discharge heads mounted on a mount 2a as a base. The head modules 6A, 6B, and 6C have the same configuration, and the recording head 3 and the recording head 4 have the same configuration. As illustrated in FIG. 1, the two recording heads 3 and 4 in each of the head modules 6A, 6B, and 6C are shifted from each other in a head transverse direction (i.e., the vertical direction in FIG. 1) and a head longitudinal direction (i.e., the horizontal direction in FIG. 1).

The two recording heads 3 and 4 are arranged such that a part of the nozzle arrays of the two recording heads 3 and 4 overlap each other in the head longitudinal direction, but the arrangement of recording heads is not limited thereto. For example, the two recording heads 3 and 4 may be arranged such that the nozzle arrays of the two recording heads 3 and 4 do not overlap each other in the head longitudinal direction and end nozzles located at adjacent ends of the nozzle arrays of the two recording heads 3 and 4 are arrayed with a predetermined nozzle pitch.

In each of the recording units 2K, 2C, 2M, and 2Y of the respective colors, the three head modules 6A, 6B, and 6C are arranged such that the recording head 3 of one of the two adjacent head modules 6A and 6B (or 6B and 6C) and the recording head 4 of the other are also shifted from each other in the head transverse direction and parts of the nozzle arrays thereof overlap each other in the head longitudinal direction (the left-right direction in FIG. 1). Thus, in the recording units 2K, 2C, 2M, 2Y and 2Y of the respective colors, the recording heads 3 and 4 are arranged in a staggered manner in a width direction of the recording material P0 (i.e., a direction orthogonal to the conveyance direction) which is the head longitudinal direction as illustrated in FIG. 1.

Such an arrangement of the recording heads 3 and 4 in each of the recording units 2K, 2C, 2M, and 2Y of the respective colors can widen a recording range by the entire recording units 2K, 2C, 2M, and 2Y (i.e., a range in which an image can be recorded by ink discharged from nozzles 11) in the head longitudinal direction. As a result, the recording units having the recording range extending in the width direction of the recording material P0 can construct the line head unit 2, so that an image can be formed on the recording material P0 in one pass without moving (scanning) the head unit 2.

For example, the number of recording units mounted on the head unit 2, the number of recording heads in the recording unit, and the type of liquid (e.g., color of ink) discharged from the recording unit can be set as desired. For example, the head unit 2 may include only the recording unit 2K for black to record in black alone.

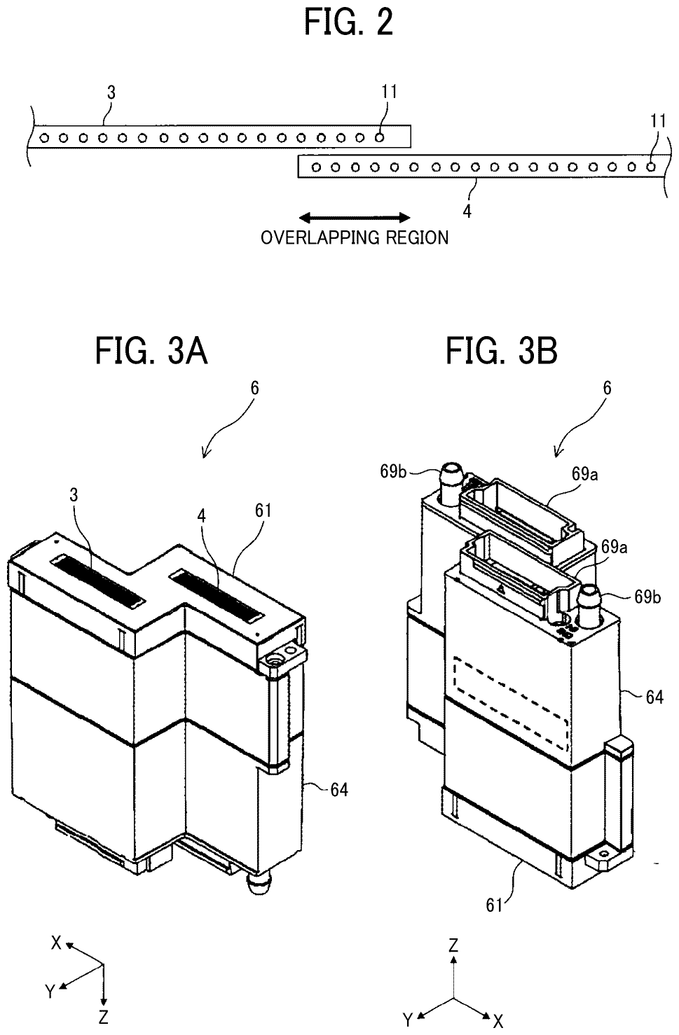

FIG. 2 is a diagram illustrating an arrangement of the recording heads 3 and 4 in each recording unit of the head unit 2. Each of the recording head 3 and the recording head 4 has a nozzle array (for example, a nozzle array including 800 nozzles) in which multiple nozzles 11 are arrayed in the head longitudinal direction. In FIG. 2, the nozzle array is one row in each of the recording head 3 and the recording head 4, but two or more nozzle arrays may be arrayed in parallel in the conveyance direction. The nozzle array may be arrayed in a nozzle array direction inclined with respect to the head longitudinal direction.

In each of the head modules 6A, 6B, and 6C, one of the recording heads 3 and 4 partially overlaps the other of the recording heads 3 and 4, and the nozzle arrays of the recording heads 3 and 4 partially overlap each other in the head longitudinal direction.

As described above, the three head modules 6A, 6B, and 6C are arranged in the head longitudinal direction to form the recording units 2K, 2C, 2M, and 2Y having a recording range extending in the width direction of the recording material P0 to construct the line head unit 2, but the head unit is not limited thereto. For example, a head unit may include a single head module 6. In this case, the head unit is mounted on a carriage which reciprocally moves in the width direction (i.e., a main scanning direction) of the recording material P0 to construct a scanning (serial) head unit.

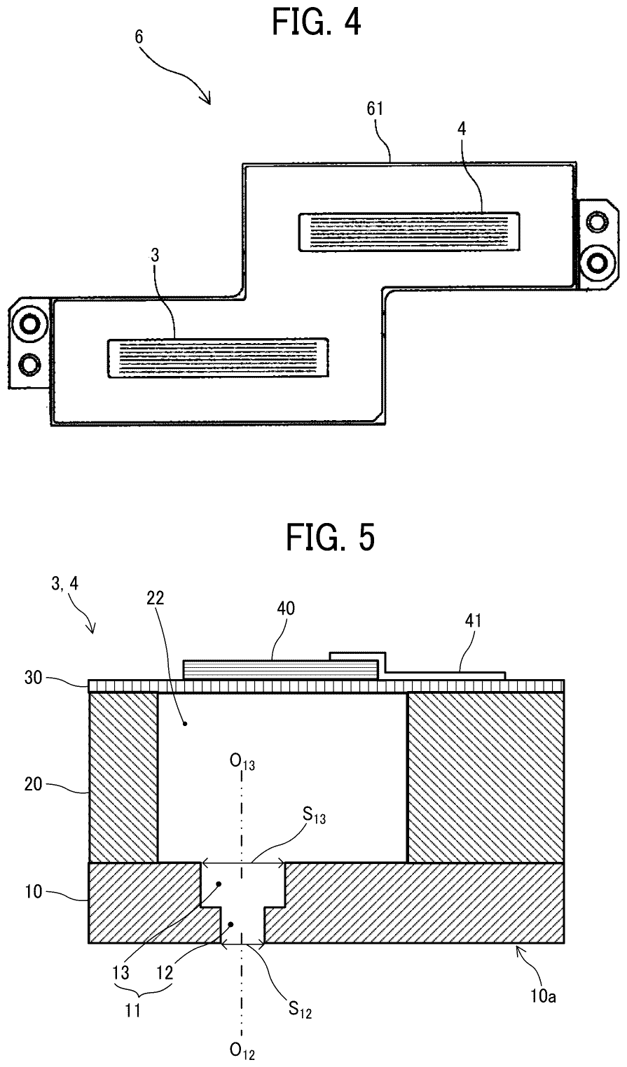

FIG. 3A is a perspective view of one head module 6 as viewed from a nozzle face (discharge face) side. FIG. 3B is a perspective view of the head module 6 of FIG. 3A as viewed from the side opposite the nozzle face. FIG. 4 is a plan view of the nozzle face of the head module 6 of FIG. 3A.

The head module 6 includes a holding plate 61 as a head holder that holds the recording heads 3 and 4 and a module body 64 in addition to the two recording heads 3 and 4. For example, the module body 64 accommodates components (e.g., a channel substrate and a piezoelectric element) of the recording heads 3 and 4 and a head driver and is provided with a connector 69a for connecting a transmission line between the head driver and a controller and an ink port 69b for supplying ink.

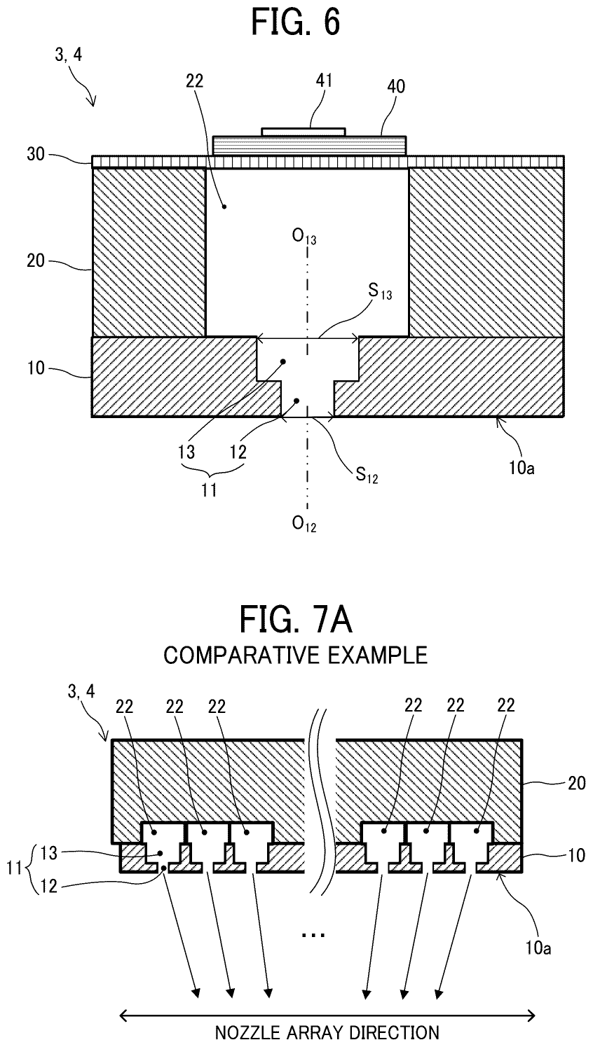

FIG. 5 is a cross-sectional view of the recording head 3 or 4 taken in a longitudinal direction of a piezoelectric element 40 at a position of one nozzle (a central nozzle in the nozzle array direction). The nozzle array direction may be referred to simply as an array direction. FIG. 6 is a cross-sectional view of the recording head 3 or 4 taken in a transverse direction of the piezoelectric element 40 at the position of the one nozzle (the central nozzle in the nozzle array direction).

Each of the recording heads 3 and 4 includes a nozzle substrate 10, an actuator substrate 20, a diaphragm 30, and piezoelectric elements 40, and is supported by a frame. The frame is a component (i.e., a partition wall) in which an ink supply port and a common liquid chamber are engraved, and is formed by, for example, resin molding. The nozzle substrate 10 has a nozzle 11. The actuator substrate 20 is a component in which a pressure chamber 22 is engraved. The diaphragm 30 is a component that is displaced (deformed) by the piezoelectric element 40, which is a pressure generator serving as an actuator element.

The nozzle substrate 10 is formed of a metal material, for example, a nickel (Ni) plating film by electroforming, and a large number of nozzles 11, which are fine discharge ports for flying ink droplets (liquid), are formed in the nozzle substrate 10. Each nozzle 11 has a nozzle outlet 12 from which the liquid is discharged in a discharge direction and a nozzle inlet 13 communicating with the pressure chamber 22. The nozzle outlet 12 is disposed downstream of the nozzle inlet 13 in the discharge direction. As illustrated in FIGS. and 6, each nozzle 11 has a cross-sectional area S₁₃ of the nozzle inlet 13 larger than a cross-sectional area S₁₂ of the nozzle outlet 12 (a cross section orthogonal to a direction of liquid flowing in the nozzle 11, i.e., a cross section parallel to a nozzle face 10a). Accordingly, the inner shape (inside shape) of the nozzle 11 is formed in a stepwise shape as illustrated in FIGS. 5 and 6. The nozzle 11 may have other shapes, such as a horn shape, a substantially cylindrical shape, and a substantially truncated cone shape, as long as the cross-sectional area S₁₃ of the nozzle inlet 13 is larger than the cross-sectional area S₁₂ of the nozzle outlet 12.

A water-repellent layer may be formed on the nozzle face 10a (ink discharge face) of the nozzle substrate 10 by a water-repellent surface treatment. The water-repellent layer may be formed by a treatment selected in accordance with the physical properties of ink from, for example, polytetrafluoroethylene (PTFE)-Ni eutectoid plating, electrodeposition of fluororesin, vapor deposition of evaporative fluororesin (e.g., pitch fluoride), firing after coating of a solution of silicon-based resin or fluorine-based resin. As a result, the shape of the droplet of the ink and the flying characteristics of the droplet are stabilized to obtain a high image quality.

The actuator substrate 20 has the pressure chamber 22 communicating with the nozzle 11. Ink is supplied to the pressure chamber 22 from the common liquid chamber formed in the frame. The pressure chamber 22 of the actuator substrate 20 has an opening on the side opposite the nozzle substrate 10, and the diaphragm 30 covers the opening of the pressure chamber 22. Thus, the diaphragm 30 serves as a wall portion, which faces the nozzle 11 across the pressure chamber 22, of the pressure chamber 22.

For example, the diaphragm 30 includes two Ni plating films laminated by electroforming. The piezoelectric element 40 is bonded to the diaphragm 30. For example, the piezoelectric element 40 includes a piezoelectric layer of lead zirconate titanate (PZT), an upper electrode (individual electrode), and a lower electrode (common electrode). The individual electrode of each piezoelectric element 40 is connected to a flexible printed circuit (FPC) via a signal line 41, and the common electrode shared by the multiple piezoelectric elements 40 is connected to a ground electrode of the FPC. A head driver, which is a head controller, is mounted on the FPC and applies a predetermined drive waveform to each piezoelectric element 40.

In each of the recording heads 3 and 4, a drive voltage having a predetermined drive waveform is applied to each piezoelectric element 40 in accordance with an image recording signal. As a result, each piezoelectric element 40 is deformed, the pressure chamber 22 is pressurized via the diaphragm 30, and the pressure in the pressure chamber 22 increases to discharge the droplets of ink from each nozzle 11. The pressure of the ink in the pressure chamber 22 decreases after the droplets of the ink are discharged, and a negative pressure is generated in the pressure chamber 22 by the inertia of the ink flowing in the pressure chamber 22 and the discharge process of the drive voltage to proceed to an ink filling step. In the ink filling step, the pressure chamber 22 is filled with the ink from the common liquid chamber.

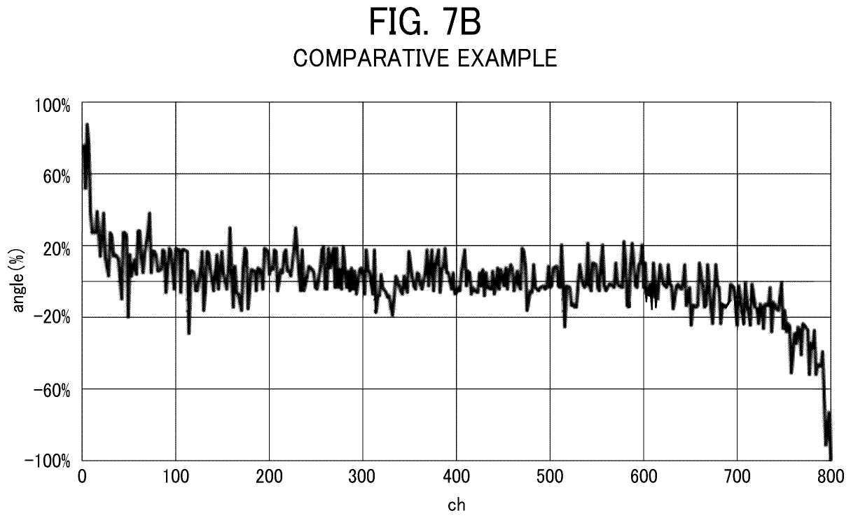

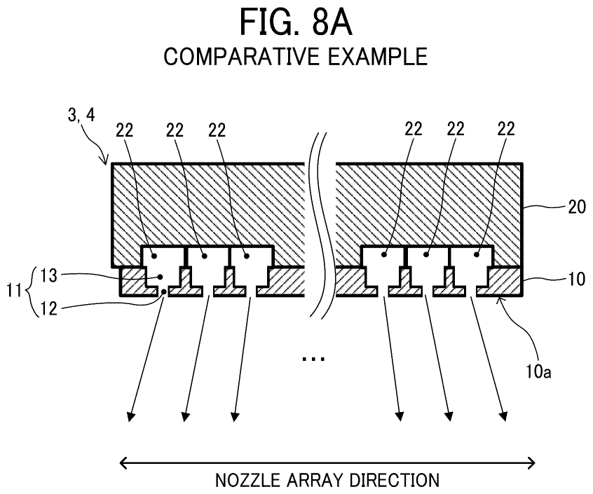

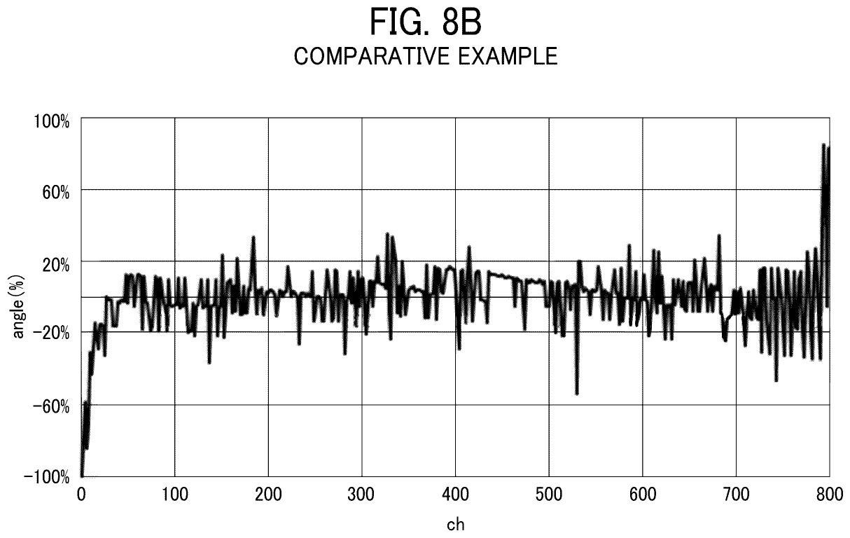

The configuration of the nozzles 11 of the recording heads 3 and 4 will be described below. FIG. 7A is a diagram illustrating a landing position deviation in a nozzle array in which multiple nozzles 11 having a typical nozzle structure are arrayed according to a comparative example. FIG. 7B is a graph illustrating the amount of the landing position deviation of FIG. 7A, which is indicated by a deviation angle generated in each nozzle. The deviation angle is an angle formed by a straight line connecting the position of a nozzle and a landing position of the droplet discharged from the nozzle and a target direction orthogonal to the nozzle face 10a. FIG. 8A is a diagram illustrating a landing position deviation in a nozzle array in which multiple nozzles 11 having the typical nozzle structure are arrayed according to another comparative example. FIG. 8B is a graph illustrating the amount of the landing position deviation of FIG. 8A, which is indicated by the deviation angle generated in each nozzle.

The typical nozzle structure of the nozzle 11 according to the comparative example means that the nozzle inlet 13 facing the pressure chamber 22 has a larger cross-sectional area than the nozzle outlet 12 from which the liquid is discharged, and a center line O₁₂ of the nozzle outlet 12 and a center line O₁₃ of the nozzle inlet 13 are aligned with each other.

In FIGS. 7B and 8B, the vertical axis represents the amount of the landing position deviation (deviation angle), which is indicated by a relative value when the absolute value of the deviation angle of the nozzle having the largest deviation angle is defined as 100% among the multiple nozzles in the nozzle array. Each of the multiple nozzles 11 may be referred to as channels ch, and denoted by ch₁, ch₂, . . . , ch_{N-1}, and ch_{N} from the left in FIGS. 7B and 8B in the nozzle array. The nozzle having the largest deviation angle is the nozzle ch_{N} (i.e., the nozzle ch₈₀₀ when the number of nozzles N in the nozzle array is 800) in FIG. 7B and the nozzle ch₁ in FIG. 8B. The amount of the landing position deviation (deviation angle) on the vertical axis of the graph in FIGS. 7B and 8B is indicated by a negative value when the discharge direction, intersecting the nozzle array direction, deviates from a target direction, which is orthogonal to the nozzle face 10a, to the left in FIGS. 7A and 8A and is indicated by a positive value when the discharge direction deviates from the target direction to the right in FIGS. 7A and 8A. The deviation angle is an angle between the discharge direction and the target direction. In other words, the discharge angle is inclined with respect to the target direction.

Typically, when liquid is discharged from each of the nozzles ch₁ to ch_{N} of the recording heads 3 and 4 to the outer region of the nozzle face 10a, and the outer region becomes a relatively negative pressure state to generate a discharge airflow. As a result, the liquid discharged from the nozzles ch₁ to ch_{N} is bent by the discharge airflow before landing on the recording material P0 to generate the landing position deviation. Further, the liquid discharged from each of the nozzles ch₁ to ch_{N} may be bent by a conveyance airflow generated by the conveyance of the recording material P0 before landing on the recording material P0 to generate the landing position deviation.

The landing position deviation of the liquid discharged from nozzles in the end regions of the nozzle array is more greatly affected by these airflows. For example, when the number of nozzles N in the nozzle array is 800, the nozzles ch₁ to chio and the nozzles ch_{N-9} to ch_{N} are greatly affected by the airflow. Accordingly, the amount of the landing position deviation is likely to be large in the nozzles located in the end regions of the nozzle array as illustrated in FIG. 7B. Whether the deviation angle is positive (i.e., plus side) or negative (i.e., minus side) depends on conditions such as the configuration of the apparatus on which the recording heads 3 and 4 are mounted.

In the comparative example, the center line O₁₃ of the nozzle inlet 13 may be offset along the nozzle array with respect to the center line O₁₂ of the nozzle outlet 12 only in the nozzles located in the end regions of the nozzle array to reduce the landing position deviation.

However, such a configuration complicates a head structure. When the head structure is complicated, it is difficult to manufacture the head and enhance the discharge accuracy of the entire head.

In addition, the cause of the landing position deviation is not limited to the above-described airflows. For example, due to other factors such as manufacturing errors during head manufacturing, the liquid discharged from each of the nozzles ch₁ to ch_{N} may not be discharged straight in the target direction orthogonal to the nozzle face 10a, but is discharged in a direction oblique to the target direction to generate the landing position deviation. As illustrated in FIGS. 7B and 8B, even in the nozzles located near the center of the nozzle array, the landing position deviation may be generated. Accordingly, even if the landing position deviation is reduced only in the nozzles in the end regions of the nozzle array, the landing position deviation of the entire head may not be reduced. The liquid discharged from the nozzles ch₁ to ch_{N} lands at landing positions on the recording material P0 with dot pitches Pd. The average value of the dot pitches Pd should be equivalent to the average value of nozzle pitches Pn of the nozzle array in which the multiple nozzles ch₁ to ch_{N} are arrayed but may deviate from the average value of the nozzle pitches Pn.

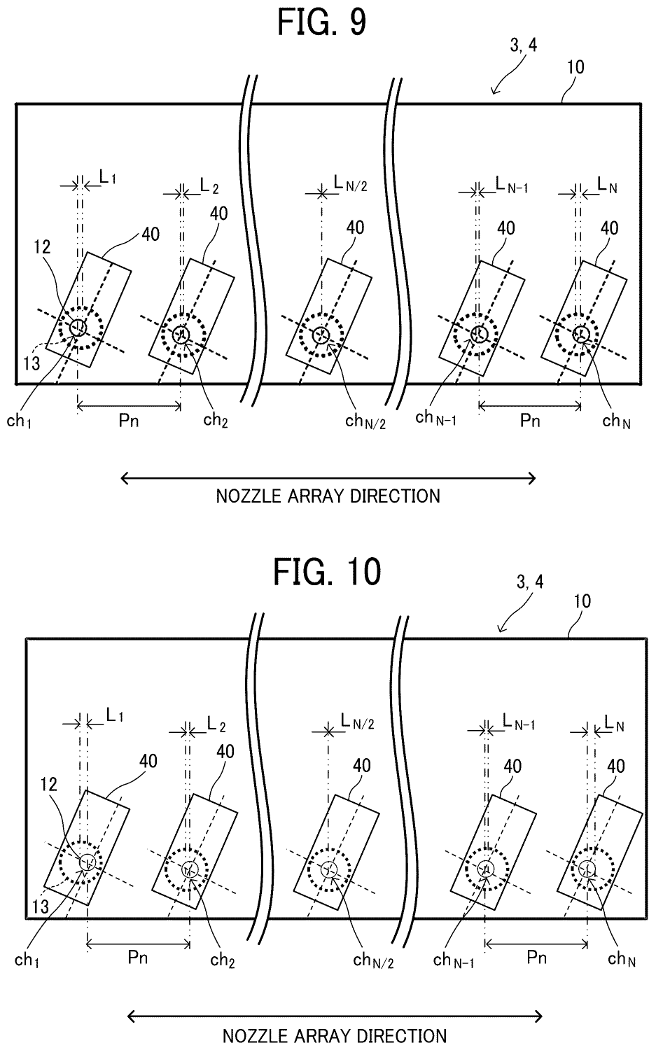

FIG. 9 is a diagram of the recording head 3 or 4 as viewed from the nozzle face 10a side, illustrating a structure (a positional relationship in an in-plane direction of the nozzle face 10a) of multiple nozzles ch₁ to ch_{N} of the nozzle array. FIG. 10 is another diagram of the recording head 3 or 4 as viewed from the nozzle face 10a side, illustrating a structure (a positional relationship in an in-plane direction of the nozzle face 10a) of multiple nozzles ch₁ to ch_{N} of the nozzle array.

As illustrated in FIGS. 5, 6, 9, and 10, each of the multiple nozzles ch₁ to ch_{N} arrayed in the nozzle array direction has a cross-sectional area of the nozzle inlet 13 on the pressure chamber side larger than a cross-sectional area of the nozzle outlet 12 on the side from which the liquid is discharged. In the multiple nozzles ch₁ to ch_{N}, shift amounts L₁ to L_{N} between the center line O₁₂ of the nozzle outlet 12 and the center line O₁₃ of the nozzle inlet 13 gradually increase from the nozzle ch_{N/2} at the center (a central nozzle) toward the nozzles ch₁ and ch_{N} at the ends (i.e. end nozzles) in the nozzle array direction as illustrated in FIGS. 9 and 10.

In the nozzles ch₁ to ch_{N/2} from the center to the left end in FIG. 9 in the nozzle array direction, the center line O₁₂ of the nozzle outlet 12 is shifted to the left in FIG. 9 (on the minus side in graph) from the center line O₁₃ of the nozzle inlet 13. Due to the shift of the center lines O₁₂ and O₁₃, when the liquid in the nozzle inlet 13 is pressurized by the pressure change in the pressure chamber by the piezoelectric element 40, a pressure deviation occurs in the nozzle outlet 12. As a result, the liquid discharged from the nozzles ch₁ to ch_{N/2} receives a discharge pressure in an oblique direction toward the end (minus side) in the nozzle array direction with respect to the target direction orthogonal to the nozzle face 10a.

In the nozzles ch_{N/2} to ch_{N} from the center to the right end in FIG. 9 in the nozzle array direction, the center line O₁₂ of the nozzle outlet 12 is shifted to the right in FIG. 9 (on the plus side in graph) from the center line O₁₃ of the nozzle inlet 13. Due to the shift of the center lines O₁₂ and O₁₃, when the liquid in the nozzle inlet 13 is pressurized by the pressure change in the pressure chamber by the piezoelectric element 40, a pressure deviation occurs in the nozzle outlet 12. As a result, the liquid discharged from the nozzles ch_{N/2} to ch_{N} receives a discharge pressure in an oblique direction toward the end (plus side) in the nozzle array direction with respect to the target direction orthogonal to the nozzle face 10a.

At this time, the larger shift amount between the center line O₁₃ of the nozzle inlet 13 and the center line O₁₂ of the nozzle outlet 12 generates the larger pressure deviation in the nozzle outlet 12. Accordingly, the direction of the discharge pressure received by the liquid discharged from the nozzle has a large inclination angle with respect to the target direction orthogonal the nozzle face 10a. As a result, the inclination angle of the direction of the discharge pressure received by the discharged liquid becomes larger in the nozzle closer to the ends in the nozzle array direction.

The configuration illustrated in FIG. 9 is suitably applied to a case where the landing position deviation as illustrated in FIG. 7A occurs in the nozzle array when the multiple nozzles having the typical nozzle structure according to the comparative example are arrayed in the nozzle array, i.e., a case where the landing position deviation occurs toward the center in the nozzle array direction with respect to the target direction orthogonal to the nozzle face in the nozzles in the end regions of the nozzle array. The configuration illustrated in FIG. 9 applied to the case where the landing position deviation as illustrated in FIG. 7A occurs can correct the landing position deviation in the nozzles in the end regions of the nozzle array.

In particular, in the head module 6, as illustrated in FIG. 2, the two recording heads 3 and 4 are arranged so that the nozzle pitch between the end nozzles positioned at one end of each of the nozzle arrays of the two recording heads 3 and 4 is a predetermined nozzle pitch. Accordingly, when the landing position deviation as illustrated in FIG. 7A occurs in the nozzles in the end regions of the nozzle arrays of the recording heads 3 and 4, a dot pitch Pd′ of the liquid discharged from the end nozzles between the two recording heads 3 and 4 becomes larger than a nozzle pitch Pn′ as illustrated in FIG. 12, and image quality deterioration such as a white stripe occurs. The configuration illustrated in FIG. 9 applied to the case where the landing position deviation as illustrated in FIG. 7A occurs can prevent the image quality deterioration such as the white streak.

Similarly, in the nozzles ch₁ to ch_{N/2} from the center to the left end in FIG. 10 in the nozzle array direction, the center line O₁₂ of the nozzle outlet 12 is shifted to the right in FIG. 10 (on the plus side in graph) from the center line O₁₃ of the nozzle inlet 13. As a result, the liquid discharged from the nozzles ch₁ to ch_{N/2} receives a discharge pressure in an oblique direction toward the center (plus side) in the nozzle array direction with respect to the target direction orthogonal to the nozzle face 10a. In the nozzles ch_{N/2} to ch_{N} from the center to the right end in FIG. 10 in the nozzle array direction, the center line O₁₂ of the nozzle outlet 12 is shifted to the left in FIG. 10 (on the minus side in graph) from the center line O₁₃ of the nozzle inlet 13. As a result, the liquid discharged from the nozzles ch_{N/2} to ch_{N} receives a discharge pressure in an oblique direction toward the center (minus side) in the nozzle array direction with respect to the target direction orthogonal to the nozzle face 10a.

The configuration illustrated in FIG. 10 is suitably applied to a case where the landing position deviation as illustrated in FIG. 8A occurs in the nozzle array when the multiple nozzles having the typical nozzle structure according to the comparative example are arrayed in the nozzle array, i.e., a case where the landing position deviation occurs toward the ends in the nozzle array direction with respect to the target direction orthogonal to the nozzle face in the nozzles in the end regions of the nozzle array. The configuration illustrated in FIG. applied to the case where the landing position deviation as illustrated in FIG. 8A occurs can correct the landing position deviation in the nozzles in the end regions of the nozzle array.

In particular, in the head module 6, as illustrated in FIG. 2, the two recording heads 3 and 4 are arranged so that the nozzle pitch between the end nozzles positioned at one end of each of the nozzle arrays of the two recording heads 3 and 4 is a predetermined nozzle pitch. Accordingly, when the landing position deviation as illustrated in FIG. 8A occurs in the nozzles in the end regions of the nozzle arrays of the recording heads 3 and 4, a dot pitch Pd′ of the liquid discharged from the end nozzles between the two recording heads 3 and 4 becomes smaller than a nozzle pitch Pn′, and image quality deterioration such as a black stripe occurs. The configuration illustrated in FIG. 10 applied to the case where the landing position deviation as illustrated in FIG. 8A occurs can prevent the image quality deterioration such as the black streak.

The configuration illustrated in FIGS. 9 and 10 is implemented by a continuous or regular configuration from the center toward the ends in the nozzle array direction for all the nozzles ch₁ to ch_{N} in the nozzle array. Accordingly, the configuration can be simplified as compared with the configuration in which only some of the multiple nozzles ch₁ to ch_{N} have a structure different from that of the remaining nozzles. As a result, the head can be easily manufactured, and the discharge accuracy of the entire head can be easily enhanced.

In particular, when the multiple nozzles ch₁ to ch_{N} have a configuration in which an amount of shift (shift amounts L₁ to L_{N}) between the center line O₁₂ of the nozzle outlet 12 and the center line O₁₃ of the nozzle inlet 13 changes symmetrically with respect to the center in the nozzle array direction (i.e., symmetrical change profile), the configuration can be further simplified. As a result, the head can be manufactured more easily, and the discharge accuracy of the entire head can be enhanced more easily.

In the configuration illustrated in FIGS. 9 and 10, since the center line O₁₃ of the nozzle inlet 13 and the center line O₁₂ of the nozzle outlet 12 are shifted from each other even in the nozzle located in a central region in the nozzle array direction, the discharge pressure in the oblique direction with respect to the target direction orthogonal to the nozzle face is generated. Accordingly, when the landing position deviation does not occur much in the nozzle having the typical nozzle structure located in the central region in the nozzle array direction, the configuration illustrated in FIGS. 9 and 10 may cause the landing position deviation in the nozzle located in the central region in the nozzle array direction.

However, in the configuration illustrated in FIGS. 9 and 10, the shift amounts L₁ to L_{N} between the center line O₁₂ of the nozzle outlet 12 and the center line O₁₃ of the nozzle inlet 13 gradually increase from the nozzle ch_{N/2} at the center toward the nozzle ch₁ and ch_{N} at the ends in the nozzle array direction. Accordingly, the pressure deviation generated in the nozzle outlet 12 is smaller and the inclination angle of the direction of the discharge pressure received by the liquid discharged from the nozzle is smaller in the nozzle located in the central region in the nozzle array direction than in the nozzle located in the end region in the nozzle array direction. As a result, even when the configuration illustrated in FIGS. 9 and 10 is applied, a large landing position deviation does not occur in the nozzle located in the central region in the nozzle array direction.

As described above, the shift amounts L₁ to L_{N} between the center line O₁₂ of the nozzle outlet 12 and the center line O₁₃ of the nozzle inlet 13 is adjusted as appropriate. Thus, the average value of the nozzle pitches Pn of the multiple nozzles ch₁ to ch_{N} can be equivalent to the average value of the dot pitches Pd of the liquid discharged from the multiple nozzles ch₁ to ch_{N}. In other words, the difference between the average value of the nozzle pitches Pn and the average value of the dot pitches Pd can be kept within a predetermined allowable range.

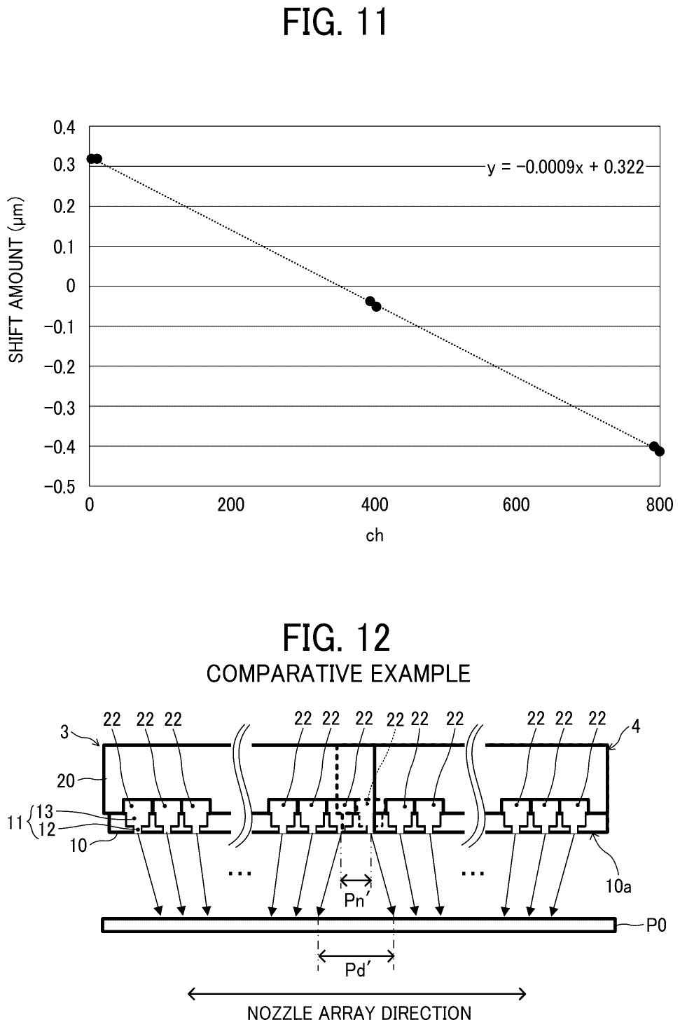

Specifically, the multiple nozzles ch₁ to ch_{N} are preferably arrayed such that the shift amounts L₁ to L_{N} changes from the nozzle ch_{N/2} at the center to the nozzles Chi and ch_{N} at the ends in the nozzle array direction with an average change rate within a range of 0.0007 μm/nozzle or more and 0.0012 μm/nozzle or less. The unit of the average change rate (μm/nozzle) means that an average length (μm) of the change in the shift amount per nozzle (i.e., between adjacent nozzles). When the average change rate of the shift amounts L₁ to L_{N} is within such a range, the average value of the nozzle pitches Pn of the multiple nozzles ch₁ to ch_{N} can easily be equivalent to the average value of the dot pitches Pd of the liquid discharged from the multiple nozzles ch₁ to ch_{N}, and the difference between the average value of the nozzle pitches Pn and the average value of the dot pitches Pd can be easily kept within the predetermined allowable range. The change rate of the shift amounts L₁ to L_{N} corresponds to the slope of the graph illustrated in FIG. 11. FIG. 11 is a graph of the shift amount of FIG. 10 when the average value of the change rate is 0.0009 μm/nozzle.

In addition, the multiple nozzles ch₁ to ch_{N} are preferably arrayed such that the shift amounts L₁ to L_{N} change from the nozzle ch_{N/2} at the center to the nozzles ch₁ and ch_{N} at the ends in the nozzle array direction within a range of 0.53 μm or more and 0.97 μm or less. When the range of the change in the shift amounts L₁ to L_{N} is within such a range, the average value of the nozzle pitches Pn of the multiple nozzles ch₁ to ch_{N} can easily be equivalent to the average value of the dot pitches Pd of the liquid discharged from the multiple nozzles ch₁ to ch_{N}, and the difference between the average value of the nozzle pitches Pn and the average value of the dot pitches Pd can be easily kept within the predetermined allowable range. In FIG. 11, the range of the change in the shift amounts L₁ to L_{N} is about 0.32 μm for the nozzles ch₁ to ch_{N/2} from the center to the left end in FIG. 11 in the nozzle array direction, and about 0.4 μm for the nozzles ch_{N/2} to ch_{N} from the center to the right end in FIG. 11 in the nozzle array direction.

In addition, the multiple nozzles ch₁ to ch_{N} are arrayed in the nozzle array such that the discharge angle of the liquid discharged from the multiple nozzles ch₁ to ch_{N} gradually changes (increases) from the nozzle ch_{N/2} at the center to the nozzles ch₁ and ch_{N} at the ends in the nozzle array direction to discharge liquid obliquely toward the center or the ends of the multiple nozzles ch₁ and ch_{N} in the nozzle array direction. At this time, an average change rate of the discharge angle from the nozzle ch_{N/2} at the center to the nozzles ch₁ and ch_{N} at the ends in the nozzle array direction is preferably within a range of 0.06 millidegree/nozzle (mdeg/nozzle) or more and 0.8 mdeg/nozzle or less. The unit of the average change rate (mdeg/nozzle) means that an average degree (mdeg) of the change in the discharge angle per nozzle (i.e., between adjacent nozzles). When the average change rate of the discharge angle is within such a range, the average value of the nozzle pitches Pn of the multiple nozzles ch₁ to ch_{N} can easily be equivalent to the average value of the dot pitches Pd of the liquid discharged from the multiple nozzles ch₁ to ch_{N}, and the difference between the average value of the nozzle pitches Pn and the average value of the dot pitches Pd can be easily kept within the predetermined allowable range.

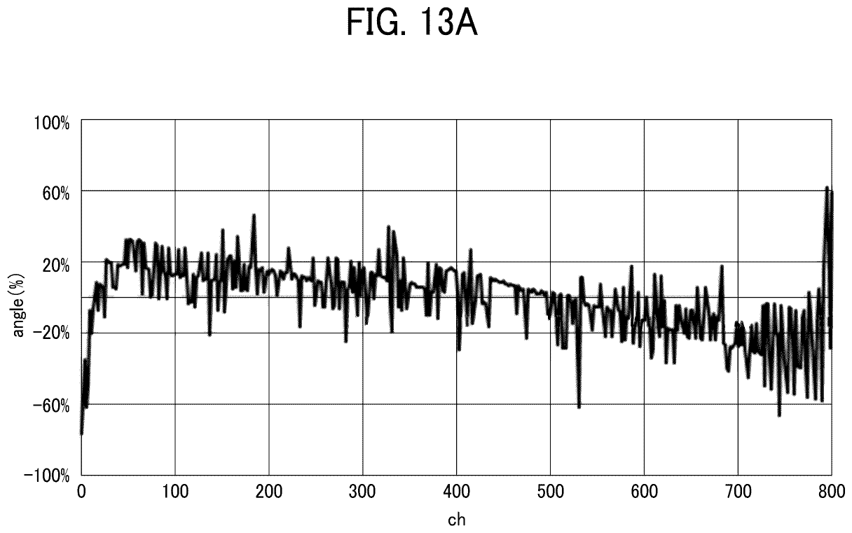

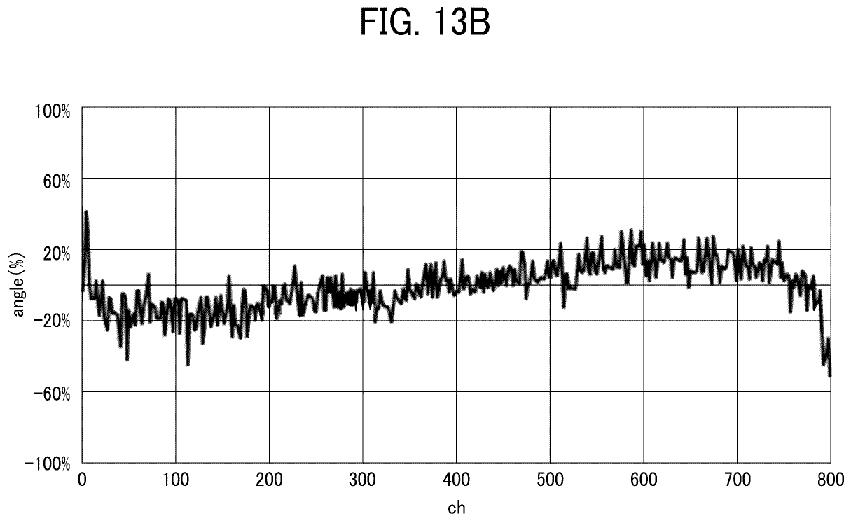

FIG. 13A is a graph illustrating the amount of a landing position deviation, which is indicated by a deviation angle, generated in each nozzle in a recording head having a configuration illustrated in FIG. 9 when the landing position deviation as illustrated in FIG. 7A occurs. As illustrated in FIG. 13A, the configuration illustrated in FIG. 9 enables the landing position deviation amount (deviation angle) to fall within a range of about 60% compared with that in FIG. 7B over the nozzles ch₁ to ch_{N} of the entire nozzle array.

FIG. 13B is a graph illustrating the amount of a landing position deviation, which is indicated by a deviation angle, generated in each nozzle in a recording head having a configuration illustrated in FIG. 10 when the landing position deviation as illustrated in FIG. 8A occurs. As illustrated in FIG. 13B, the configuration illustrated in FIG. 10 enables the landing position deviation amount (deviation angle) to fall within a range of about 50% compared with that in FIG. 8B over the nozzles ch₁ to ch_{N} of the entire nozzle array.

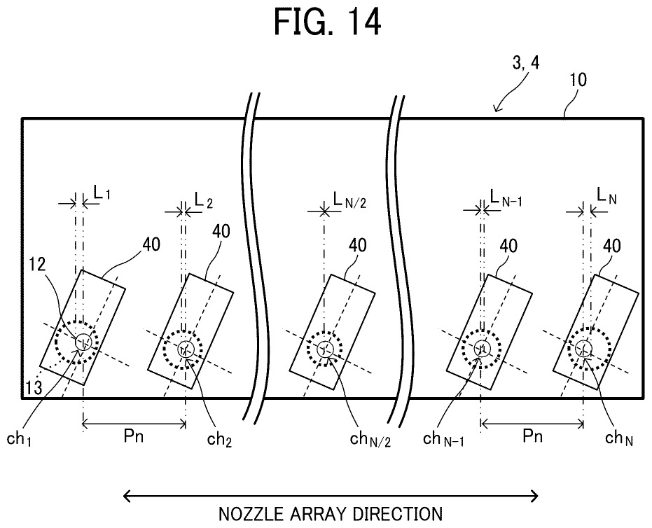

The pressure deviation in the nozzle outlet 12 causes the liquid to be discharged from the nozzle to receive the discharge pressure in the oblique direction. The pressure deviation can be changed by the shift amount between the center line O₁₃ of the nozzle inlet 13 and the center line O₁₂ of the nozzle outlet 12 and also by the difference of the cross-sectional areas of the nozzle inlet 13 and the nozzle outlet 12. As illustrated in FIG. 14, the multiple nozzles ch₁ to ch_{N} may be arrayed in the nozzle array such that the difference of the cross-sectional areas of the nozzle inlet 13 and the nozzle outlet 12 gradually increases from the nozzle ch_{N/2} at the center toward the nozzles ch₁ and ch_{N} at the ends in the nozzle array direction, in addition to the configuration in which the shift amounts L₁ to L_{N} between the center line O₁₂ of the nozzle outlet 12 and the center line O₁₃ of the nozzle inlet 13 gradually increase from the nozzle ch_{N/2} at the center toward the nozzles ch₁ and ch_{N} at the ends in the nozzle array direction.

Such a configuration can correct the landing position deviation of the nozzles in the end regions in the nozzle array direction more greatly than that of the nozzles in the central region in the nozzle array direction. The large landing position deviation is more likely to occur largely in the end regions than the central region due to the influence of the airflow. Accordingly, the average value of the nozzle pitches Pn of the multiple nozzles ch₁ to ch_{N} can easily be equivalent to the average value of the dot pitches Pd of the liquid discharged from the multiple nozzles ch₁ to ch_{N}, and the difference between the average value of the nozzle pitches Pn and the average value of the dot pitches Pd can be easily kept within the predetermined allowable range.

Such a configuration is implemented by a continuous or regular configuration from the center toward the ends in the nozzle array direction. As a result, the configuration of the head can be simplified, the head can be easily manufactured, and the discharge accuracy of the entire head can be easily enhanced as compared with the comparative example.

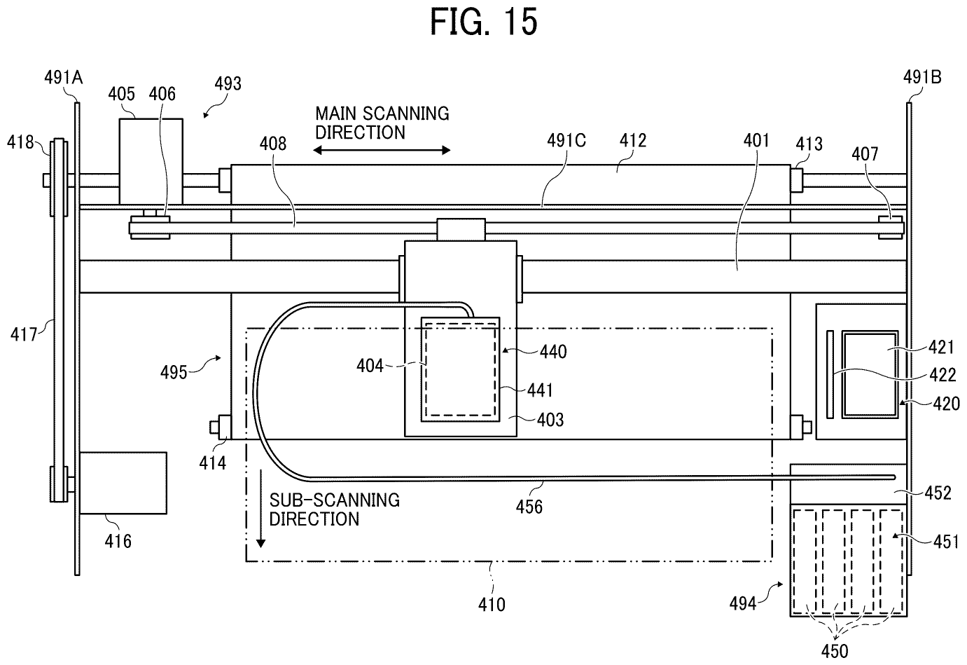

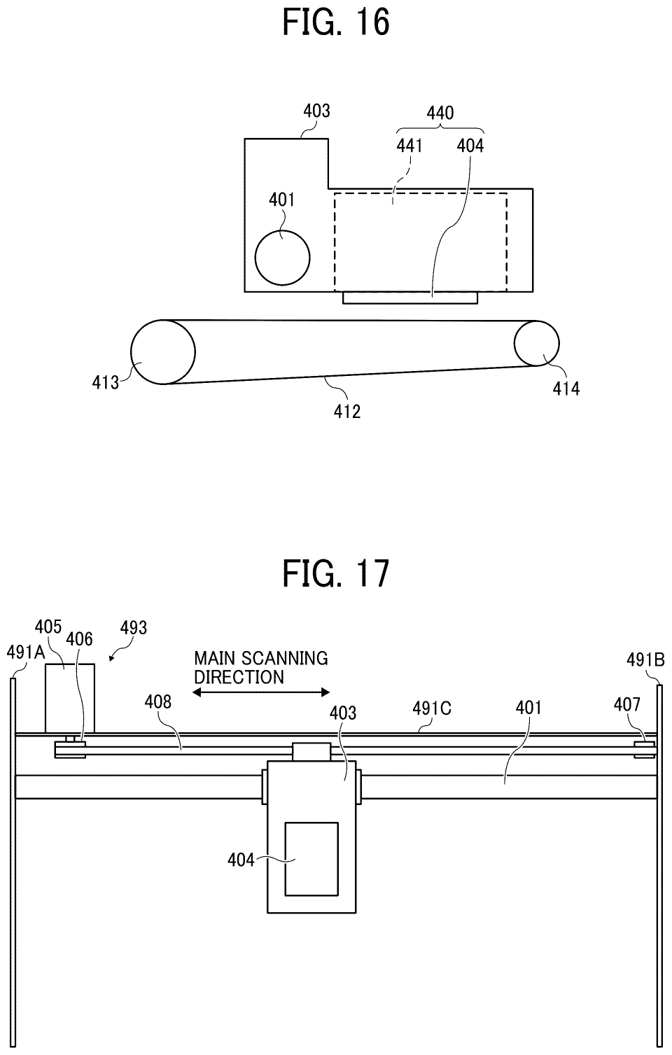

A liquid discharge apparatus is described below with reference to FIGS. 15 and 16. FIG. 15 is a plan view of a part of the liquid discharge apparatus. FIG. 16 is a side view of the part of the liquid discharge apparatus.

The liquid discharge apparatus is a serial-type apparatus in which a main-scanning moving mechanism 493 reciprocates a carriage 403 in a main scanning direction orthogonal to the target direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which a head module 404 and a head tank 441 are integrated into a single unit. The head module 404 of the liquid discharge unit 440 includes, for example, recording units that discharge liquids of the respective colors of yellow (Y), cyan (C), magenta (M), and black (K), similarly to the head unit 2 described above. In the head module 404, each of the recording units of the respective colors includes the multiple head modules 6 each including the recording heads 3 and 4. The recording heads 3 and 4 each having a nozzle array including multiple nozzles are arrayed in a staggered manner. The multiple nozzles are arrayed in the nozzle array direction, which is a sub-scanning direction (head longitudinal direction) orthogonal to the main scanning direction, and the recording heads 3 and 4 discharge liquid downward in the discharge direction, similarly to the recording units 2K, 2C, 2M, and 2Y described above.

A supply mechanism 494 disposed outside the head module 404 supplies liquid stored in liquid cartridges 450 to the head tank 441 to supply the liquid to the head module 404. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the head module 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the head module 404 is disposed lateral to the conveyance belt 412. The maintenance mechanism 420 includes, for example, a cap 421 to cap the nozzle face (i.e., a face on which nozzles are formed) of the head module 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves. The head module 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head, thus allowing the stable formation of high-quality images.

Another liquid discharge unit is described below with reference to FIG. 17. FIG. 17 is a plan view of a part of the liquid discharge unit. The liquid discharge unit includes the housing, the main-scanning moving mechanism 493, the carriage 403, and the head module 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

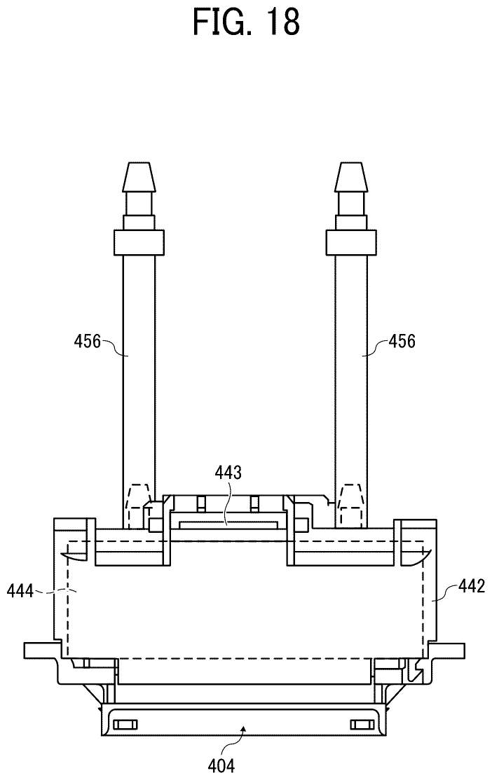

Still another liquid discharge unit is described below with reference to FIG. 18. FIG. 18 is a front view of the liquid discharge unit. The liquid discharge unit includes the head module 404 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the head module 404 is disposed on an upper portion of the channel component 444.

In the above-described embodiments, the “liquid discharge apparatus” includes the liquid discharge head, the head module, or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording material (medium) such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a head module (liquid discharge head) and a head tank are integrated, as illustrated in FIG. 16. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit illustrated in FIG. 17, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 18.

The main-scanning moving mechanism may be a guide only. The supply mechanism may be a tube(s) only or a loading device only.

The actuator element used in the liquid discharge head is not limited to a particular type of pressure generator. The pressure generator is not limited to the piezoelectric element (or a laminated piezoelectric element) described in the above-described embodiments, and may be, for example, a thermal actuator that employs an electrothermal transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

The embodiments described above are presented as examples and are not intended to limit the scope of the present disclosure. The above-described novel embodiments can be implemented in other various forms, and various omissions, replacements, and changes can be made without departing from the scope of the disclosure. These embodiments and modifications or variations thereof are included in the scope and gist of the present disclosure, and are included in the scope of claims and the equivalent scope thereof.

The embodiments described above are just examples, and the various aspects of the present disclosure attain respective effects as follows.

### Aspect 1

A liquid discharge head, such as the recording heads 3 and 4, includes multiple nozzles, such as the multiple nozzles 11 (e.g., the multiple nozzles ch₁ to ch_{N}), arrayed in a predetermined array direction (nozzle array direction); multiple pressure chambers, such as the multiple pressure chambers 22, respectively communicating with the multiple nozzles; a diaphragm, such as the diaphragm 30, defining wall portions of the multiple pressure chambers; and an actuator element, such as the piezoelectric element 40, to drive the diaphragm. The nozzle has the nozzle inlet 13 on the pressure chamber side having a larger cross-sectional area than the nozzle outlet 12 on the liquid discharge side. The multiple nozzles ch₁ to ch_{N} have a configuration in which the shift amounts L₁ to L_{N} between the center line O₁₂ of the nozzle outlet 12 and the center line O₁₃ of the nozzle inlet 13 gradually increase from the nozzle ch_{N/2} at the center toward the nozzles ch₁ and ch_{N} at the respective ends in the array direction so that the average value of the nozzle pitches Pn in the array direction and the average value of the dot pitches Pd of the liquid discharged from the multiple nozzles substantially coincide with each other.

In other words, a liquid discharge head includes a nozzle substrate, an actuator substrate, a diaphragm, and an actuator element. The nozzle substrate has multiple nozzles arrayed in an array direction on a nozzle face to discharge a liquid from the multiple nozzles in a discharge direction intersecting the array direction. The actuator substrate is disposed on the nozzle substrate. The actuator substrate has multiple pressure chambers arrayed in the array direction and respectively communicating with the multiple nozzles. The diaphragm is disposed on the actuator substrate. The diaphragm has wall portions respectively facing the multiple nozzles across the multiple pressure chambers in the discharge direction. The actuator element is disposed on the diaphragm to deform the diaphragm. Each of the multiple nozzles has a nozzle inlet communicating with a corresponding pressure chamber of the multiple pressure chambers and a nozzle outlet downstream of the nozzle inlet in the discharge direction. The nozzle inlet has a first cross-sectional area orthogonal to a target direction orthogonal to the nozzle face and a first center line at a center of the nozzle inlet in the array direction. The nozzle outlet has a second cross-sectional area orthogonal to the target direction and a second center line at a center of the nozzle outlet in the array direction. The second cross-sectional area is smaller than the first cross-sectional area. The second center line is shifted from the first center line in the array direction for a shift amount that gradually increases from a center of the multiple nozzles toward each end of the multiple nozzles in the array direction.

Further, the multiple nozzles are arrayed at an average nozzle pitch in the array direction, and the multiple nozzles discharge the liquid onto a medium to form an image of dots at an average dot pitch equivalent to the average nozzle pitch in the array direction on the medium.

In the liquid discharge head according to the comparative example, the multiple nozzles are arrayed in the array direction to form the nozzle array, and in only ten nozzles arrayed in the end region of the nozzle array extending in the array direction, the center line of the nozzle inlet is offset toward an end side of the nozzle array with respect to the center line of the nozzle outlet to prevent the landing position deviation. Accordingly, only some of the multiple nozzles (only the ten nozzles) in the nozzle array have a configuration different from that of the remaining nozzles, and thus the head structure becomes complicated. When the head structure is complicated, the head manufacturing is likely to be difficult. If the head manufacturing becomes difficult, it is difficult to enhance the discharge accuracy of the entire head.

In addition, the landing position deviation occurs due to not only the discharge airflow but also the influence of other airflows such as the conveyance airflow caused by the conveyance of the medium onto which the discharged liquid lands. In addition, the landing position deviation occurs due to, for example, the influence of manufacturing errors at the time of manufacturing the head. Accordingly, even if the landing position deviation is prevented only in the nozzles in the end region of the nozzle array, the landing position deviation of the entire head may not be prevented. As a result, the liquid discharged from the multiple nozzles may land at undesired landing positions on the recording material with dot pitches. In other words, the average value of the dot pitches Pd should be equivalent to the average value of nozzle pitches of the nozzle array in which the multiple nozzles are arrayed but may largely deviate from the average value of the nozzle pitches.

In this aspect, the multiple nozzles arrayed in the array direction have a larger cross-sectional area at the nozzle inlet on the pressure chamber side than at the nozzle outlet on the side from which the liquid is discharged. The shift amounts between the center line of the nozzle outlet and the center line of the nozzle inlet gradually increase from the nozzle at the center toward the nozzles at the ends in the array direction. Such a configuration can be implemented by a continuous or regular configuration from the center toward the ends in the array direction for all the nozzles in the multiple nozzles. Accordingly, the configuration can be simplified as compared with the configuration in which only some of the multiple nozzles have a structure different from that of the remaining nozzles. As a result, the head can be easily manufactured, and the discharge accuracy of the entire head can be easily enhanced.

Further, in this aspect, since the average value of the nozzle pitch in the array direction, in which the multiple nozzles are arrayed, and the average value of the dot pitch of the liquid discharged from the multiple nozzles are substantially coincide with each other, the landing position deviation of the entire head can be prevented as compared with the comparative example. In particular, the landing position deviation due to various influences is likely to gradually increase from the center toward the end in the array direction. In this aspect, such a landing position deviation can be prevented in the entire head.

### Aspect 2

In the liquid discharge head according to Aspect 1, the multiple nozzles are arrayed such that an average value of a change rate of the shift amounts from the nozzle at the center to the nozzles at the respective ends is within a range of 0.0007 μm/nozzle or more and 0.0012 μm/nozzle or less.

In other words, the shift amount changes from the center to the end of the multiple nozzles with an average change rate of 0.0007 μm/nozzle or more and 0.0012 μm/nozzle or less.

According to this configuration, the average value of the nozzle pitches in the array direction in which the multiple nozzles are arrayed can easily be equivalent to the average value of the dot pitches of the liquid discharged from the multiple nozzles, and the difference between the average value of the nozzle pitches and the average value of the dot pitches can be easily kept within a predetermined allowable range.

### Aspect 3

In the liquid discharge head according to Aspect 1 or 2, the multiple nozzles are arrayed such that a range of change in the shift amount from the nozzle at the center to the nozzles at the respective ends is within a range of 0.53 μm or more and 0.97 μm or less. In other words, the shift amount changes from the center to the end of the multiple nozzles within a range of 0.53 μm or more and 0.97 μm or less.

According to this configuration, the average value of the nozzle pitches in the array direction in which the multiple nozzles are arrayed can easily be equivalent to the average value of the dot pitches of the liquid discharged from the multiple nozzles, and the difference between the average value of the nozzle pitches and the average value of the dot pitches can be easily kept within a predetermined allowable range.

### Aspect 4

In the liquid discharge head according to any one of Aspects 1 to 3, the multiple nozzles are arrayed such that a change profile of the shift amount is symmetrical with respect to the center in the array direction.

In other words, the shift amount changes symmetrically with respect to the center of the multiple nozzles in the array direction.

According to this configuration, the configuration of the liquid discharge head can be further simplified, the head can be further easily manufactured, and the discharge accuracy of the entire head can be further easily enhanced.

### Aspect 5

In the liquid discharge head according to any one of Aspects 1 to 4, the multiple nozzles are arrayed such that the discharge angle of the liquid discharged from the multiple nozzles gradually changes from the nozzle at the center to the nozzles at the respective ends in the array direction toward the end side or the center side, and an average value of a change rate of the discharge angle from the nozzle at the center to the nozzles at the respective ends is within a range of 0.06 mdeg/nozzle or more and 0.8 mdeg/nozzle or less.

In other words, the multiple nozzles discharge the liquid at discharge angles inclined with respect the target direction and increasing from the center toward the end of the multiple nozzles in the array direction. The discharge angles change at an average change rate from the center to the end of the multiple nozzles within a range of 0.06 mdeg/nozzle or more and 0.8 mdeg/nozzle or less.

According to this configuration, the average value of the nozzle pitches in the array direction in which the multiple nozzles are arrayed can easily be equivalent to the average value of the dot pitches of the liquid discharged from the multiple nozzles, and the difference between the average value of the nozzle pitches and the average value of the dot pitches can be easily kept within a predetermined allowable range.

### Aspect 6

A head module includes one or more liquid discharge heads including the liquid discharge head according to any one of Aspects 1 to 5.

The head module can be provided, which can simplify a configuration for correcting the landing positions of the liquid droplets discharged from the nozzles and deviating from the target landing positions.

### Aspect 7

A liquid discharge unit includes the liquid discharge head according to any one of Aspects 1 to 5 or the head module according to Aspect 6.

In other words, a liquid discharge unit includes the liquid discharge head according to any one of Aspects 1 to 5 or the head module according to Aspect 6, and a supply mechanism to supply the liquid to the liquid discharge head or the head module.

The liquid discharge unit can be provided, which can simplify a configuration for correcting the landing positions of the liquid droplets discharged from the nozzles and deviating from the target landing positions.

### Aspect 8

The liquid discharge unit according to Aspect 7, further includes at least one of a head tank to store a liquid to be supplied to the liquid discharge head (or the head module), a carriage to mount the liquid discharge head (or the head module), the supply mechanism to supply the liquid to the liquid discharge head (or the head module), a maintenance mechanism to maintain and recover the liquid discharge head (or the head module), or a main-scanning moving mechanism to move the carriage in a main scanning direction orthogonal to the target direction. The at least one of the head tank, the carriage, the supply mechanism, the maintenance mechanism, or the main-scanning moving mechanism with the liquid discharge head (or the head module) form a single unit.

The liquid discharge unit can be provided, which can simplify a configuration for correcting the landing positions of the liquid droplets discharged from the nozzles and deviating from the target landing positions.

### Aspect 9

A liquid discharge apparatus includes the liquid discharge head according to any one of Aspects 1 to 5, the head module according to Aspect 6, or the liquid discharge unit according to Aspect 7 or 8.

In other words, a liquid discharge apparatus includes the liquid discharge head according to any one of Aspects 1 to 5, the head module according to Aspect 6, or the liquid discharge unit according to Aspect 7 or 8, to discharge the liquid to a medium; and a conveyor to convey the medium to the liquid discharge head, the head module, or the liquid discharge unit.

The liquid discharge apparatus can be provided, which can simplify a configuration for correcting the landing positions of the liquid droplets discharged from the nozzles and deviating from the target landing positions.

As described above, according to one aspect of the present disclosure, a configuration for correcting the landing positions of the liquid droplets, which are discharged from the nozzles, deviating from the target landing positions can be simplified.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle substrate having multiple nozzles arrayed in an array direction on a nozzle face to discharge a liquid from the multiple nozzles in a discharge direction intersecting the array direction;
an actuator substrate on the nozzle substrate, the actuator substrate having multiple pressure chambers arrayed in the array direction and respectively communicating with the multiple nozzles;
a diaphragm on the actuator substrate, the diaphragm having wall portions respectively facing the multiple nozzles across the multiple pressure chambers in the discharge direction; and
an actuator element on the diaphragm to deform the diaphragm,
wherein each of the multiple nozzles has:
a nozzle inlet communicating with a corresponding pressure chamber of the multiple pressure chambers; and
a nozzle outlet downstream of the nozzle inlet in the discharge direction,
the nozzle inlet has:
a first cross-sectional area orthogonal to a target direction orthogonal to the nozzle face; and
a first center line at a center of the nozzle inlet in the array direction,
the nozzle outlet has:
a second cross-sectional area orthogonal to the target direction, the second cross-sectional area smaller than the first cross-sectional area; and
a second center line at a center of the nozzle outlet in the array direction, and
the second center line is shifted from the first center line in the array direction for a shift amount that gradually increases from a center of the multiple nozzles toward each end of the multiple nozzles in the array direction.

2. The liquid discharge head according to claim 1,
wherein the multiple nozzles are arrayed at an average nozzle pitch in the array direction, and
the multiple nozzles discharge the liquid onto a medium to form an image of dots at an average dot pitch equivalent to the average nozzle pitch in the array direction on the medium.

3. The liquid discharge head according to claim 1,
wherein the shift amount changes from the center to the end of the multiple nozzles with an average change rate of 0.0007 μm/nozzle or more and 0.0012 μm/nozzle or less.

4. The liquid discharge head according to claim 1,
wherein the shift amount changes from the center to the end of the multiple nozzles within a range of 0.53 μm or more and 0.97 μm or less.

5. The liquid discharge head according to claim 1,
wherein the shift amount changes symmetrically with respect to the center of the multiple nozzles in the array direction.

6. The liquid discharge head according to claim 1,
wherein the multiple nozzles discharge the liquid at discharge angles:
inclined with respect the target direction; and
increasing from the center toward the end of the multiple nozzles in the array direction, and
the discharge angles change at an average change rate from the center to the end of the multiple nozzles within a range of 0.06 mdeg/nozzle or more and 0.8 mdeg/nozzle or less.

7. A head module comprising:
one or more liquid discharge heads including the liquid discharge head according to claim 1.

8. A liquid discharge unit comprising:
the liquid discharge head according to claim 1; and
a supply mechanism to supply the liquid to the liquid discharge head.

9. The liquid discharge unit according to claim 8, further comprising at least one of:
a head tank to store the liquid to be supplied to the liquid discharge head;
a carriage to mount the liquid discharge head;
the supply mechanism to supply the liquid to the liquid discharge head;
a maintenance mechanism to maintain and recover the liquid discharge head; or
a main-scanning moving mechanism to move the carriage in a main scanning direction orthogonal to the target direction,
wherein the at least one of the head tank, the carriage, the supply mechanism, the maintenance mechanism, or the main-scanning moving mechanism with the liquid discharge head form a single unit.

10. A liquid discharge unit comprising:
the head module according to claim 7; and
a supply mechanism to supply the liquid to the head module.

11. The liquid discharge unit according to claim 10, further comprising at least one of:
a head tank to store the liquid to be supplied to the head module;
a carriage to mount the head module;
the supply mechanism to supply the liquid to the head module;
a maintenance mechanism to maintain and recover the head module; or
a main-scanning moving mechanism to move the carriage in a main scanning direction orthogonal to the target direction,
wherein the at least one of the head tank, the carriage, the supply mechanism, the maintenance mechanism, or the main-scanning moving mechanism with the head module form a single unit.

12. A liquid discharge apparatus comprising:
the liquid discharge head according to claim 1, to discharge the liquid to a medium; and
a conveyor to convey the medium to the liquid discharge head.

13. A liquid discharge apparatus comprising:
the head module according to claim 7, to discharge the liquid to a medium; and
a conveyor to convey the medium to the head module.

14. A liquid discharge apparatus comprising:
the liquid discharge unit according to claim 8, to discharge the liquid to a medium; and
a conveyor to convey the medium to the liquid discharge unit.
